(19) United States
(12) Patent Application Publication
(10) Pub. No.: US 2014/0013858 A1
(43) Pub. Date: Jan. 16, 2014

(54) Measuring Tube Lining

(71) Applicants: Johannes Ruchel, Arlesheim (CH); Wolfgang Brobeil, Weil am Rhein (DE)

(72) Inventors: Johannes Ruchel, Arlesheim (CH); Wolfgang Brobeil, Weil am Rhein (DE)

(73) Assignee: Endress + Hauser FLowtec AG, Reinach (CH)

(21) Appl. No.: 14/009,546

(22) PCT Filed: Feb. 15, 2012
(86) PCT No.: PCT/EP2012/054531

§ 371 Date: Oct. 3, 2013

(30) Foreign Application Priority Data
Apr. 4, 2011 (DE) 10 2011 006 731.0

(51) Int. Cl. C08G 71/04; G01F 1/58; F16L 11/12; C08F 14/26; C08F 14/18; G01F 1/00; C08F 8/00

(52) U.S. Cl. CPC C08G 71/04; G01F 1/00; G01F 1/58; C08F 8/00; C08F 14/26; C08F 14/185; F16L 11/12
USPC 73/861.12; 73/861; 525/326.2; 525/453; 526/242; 528/85; 428/36.91; 138/140

(57) ABSTRACT

A measuring tube for a lining of a measuring tube of a flow measuring device, wherein a nanoparticle is chemically bound to a polymer.

The present invention relates to method for manufacturing a synthetic material or plastic for a lining of a measuring tube of a flow measuring device.

Measuring tubes for flow measuring devices of the process industry are a familiar topic for those skilled in the art.

By means of in-line measuring devices having a magneto inductive measuring transducer, it is known to measure the flow velocity and/or the volume flow of an electrically conductive fluid flowing in a flow direction through a measuring tube of the measuring transducer. For this, there is produced in the magneto inductive measuring transducer, by means of most often diametrally oppositely lying field coils of a magnetic circuit arrangement electrically connected to an exciter electronics of the in-line measuring device, a magnetic field, which passes through the fluid within a predetermined measuring volume at least sectionally perpendicular to the flow direction and closes upon itself essentially outside of the fluid. The measuring tube is composed, consequently, usually of non-ferromagnetic material, in order that the magnetic field not be unfavorably influenced during the measuring. As a result of the movement of the free charge carriers of the fluid in the magnetic field according to the magneto hydrodynamic principle, there is produced in the measurement volume an electrical field, which extends perpendicularly to the magnetic field and perpendicular to the flow direction of the fluid. By means of at least two measuring electrodes arranged spaced from one another in the direction of the electrical field and by means of an evaluating electronics of the in-line measuring device connected to these, thus, an electrical voltage induced in the fluid is measurable, which is, in turn, a measure for the volume flow. Serving for tapping the induced voltage can be, for example, fluid contacting, galvanic electrodes or non-fluid contacting, capacitively measuring electrodes. For guiding and in-coupling the magnetic field into the measurement volume, the magnetic circuit arrangement usually includes, encased by the field coils, coil cores, which are arranged along a periphery of the measuring tube, especially spaced diametrally from one another and having, in each case, a free, terminal, end face. These terminal end faces are arranged spaced from one another, especially as mirror images of one another. In operation, thus, the magnetic field produced by means of the field coils connected to the exciter electronics is coupled via the coil cores so into the measuring tube that it passes through the fluid flowing between the two end faces at least sectionally perpendicular to the flow direction.

Used often as an alternative to in-line measuring devices with magneto inductive measuring transducers are acoustic in-line measuring devices for measuring flow velocities and/or volume flow flowing fluids by means of ultrasound.

Due to the required high mechanical stability for such measuring tubes, these are—both in the case of magneto inductively measuring transducers as well as also for acoustically measuring transducers—most often composed of an outer, especially metal, support tube of predeterminable strength and size, which is coated internally with an electrically non-conducting, insulating material of predeterminable thickness, the so-called lining, or liner. For example, described in U.S. Pat. No. 6,595,069, U.S. Pat. No. 5,664,315, U.S. Pat. No. 5,280,727, U.S. Pat. No. 4,679,442, U.S. Pat. No. 4,253,340, U.S. Pat. No. 3,213,685 or JP-Y 53-51 181 are, in each case, magneto inductive measuring transducers, which comprise a measuring tube, which is insertable fluid-tightly into a pipeline at an inlet side, first end and an outlet side, second end. The measuring tube includes: a non-ferromagnetic support tube serving as an outer jacket of the measuring tube; and a tubular lining accommodated in a lumen of the support tube and composed of an insulating material for conveying a flowing fluid insulated from the support tube.

The lining, which is usually of a thermoplastic, thermosetting or elastomeric, synthetic material or plastic, serves for chemically isolating the support tube from the fluid. In the case of magneto inductive measuring transducers, in which the support tube has a high electrical conductivity, for example, in the case of application of metal support tubes, the lining serves, moreover, as electrical insulation between the support tube and the fluid, which prevents a short circuiting of the electrical field via the support tube. Through a corresponding design of the support tube, there is thus achieved a matching of the strength of the measuring tube to the mechanical loadings present in the respective instance of use, while the lining provides a matching of the measuring tube to the chemical and/or biological requirements needed for the respective instance of use.

Because of their good workability, on the one hand, and their good chemical and mechanical properties, on the other hand, besides hard rubber or fluorine-containing, synthetic materials or plastics, such as e.g. PTFE, PFA, in special measure also polyurethanes have established themselves as materials for the linings of in-line measuring devices, especially such with magneto inductively measuring transducers. Additionally, linings of polyurethane have, especially also in bacteriological regard, most often good biological properties and are, insofar, also well suitable for application for aqueous fluids.

The polyurethanes used for the manufacture of linings of the described type are produced, most often directly before application, from liquid multicomponent systems formed of reactive starting components. The liquid multicomponent system resulting from the mixing of the starting components is applied to the inner wall of the support tube treated earlier with tackifier and there caused to harden within a predeterminable reaction time to form the lining. Polyurethanes are, as is known, produced by polyaddition reactions of di- and poly-isocyanates and alcohols having two or more functional groups. Serving as starting components, in such case, can be, for example, prepolymers constructed of aliphatic and/or aromatic ether groups as well as glycol- and isocyanate groups, which can react with the supplied two- or multifunctional alcohol.

For manufacturing linings of polyurethane, often a so-called ribbon-flow method is applied, in the case of which the earlier manufactured liquid multicomponent system is uniformly distributed by means of a corresponding casting- or spray head on the inner wall of the support tube moved in suitable manner. DE-A 10 2004 059 525 discloses such an incursion apparatus for coating a tube to produce a lining. The reaction time of the multicomponent system required thereafter for curing can be adjusted besides by the metering of the starting components in considerable measure also by a suitable control of the working temperature. However, short reaction times of less than a minute, such as are required for cost effective manufacture of the lining at a working temperature lying, for instance, at room temperature, can usually only be achieved by adding a suitable, most often heavy metal- and/or amine containing catalyst to the multicomponent system. Suitable catalysts, in such case, are, especially, tertiary amines and/or mercury. Considering that the catalyst itself remains essentially unchanged in the manufacture of polyurethane, such brings with it, insofar, unavoidably even toxic, at least, however, physiologically not completely non-hazardous, combinations. Numerous investigations have additionally shown that especially the catalyst, at least in the case of presence of water, can in considerable measure be dissolved out of the lining. Insofar, the polyurethanes currently used in in-line measuring devices are only conditionally suitable for applications with high hygienic requirements, such as e.g. for measurements in the drinking water domain, since the high requirements specified for drinking water for fluid contacting components as regards chemical durability as well as physiological compatibility can no longer be directly fulfilled. Special attention in the case of drinking water is given, among other things, to maintaining a maximum tolerable migration rate (Mmax, TOC) as regards total organic carbon content (TOC) and/or specific migration limit values (SML) for defined toxicological critical substances. Equally strong are the requirements as regards the effect of the lining on the external characteristics of drinking water, especially as regards taste-, color- turbidity—and/or smell neutrality of the lining in the presence of water, and as regards maximum tolerable chlorine attrition rates (Mmax, C1).

WO 2006/067077 discloses a further method for manufacturing a lining of an in-line flow measuring device.

An object of the invention is to provide a method for manufacturing a lining for a measuring tube for a flow measuring device, wherein the properties of the lining are stable.

The object is achieved by the subject matter defined in the independent claims 1 and 11. Further developments and embodiments of the invention are provided by the features of the respective dependent claims.

The invention permits numerous forms of embodiment. Some thereof will now be explained in greater detail.

According to the invention, a nanoparticle is chemically bound to a polymer. In this regard, the nanoparticle can also be bound to a monomer or an oligomer of the subsequent polymer. Polymers of the invention with nanoparticles chemically bound thereto form the main component of the synthetic material or plastic of the invention.

If a nanoparticle is chemically bound to a polymer, it is chemically bonded with at least one basic building block of the polymer. For practical purposes, a plurality of nanoparticles are chemically bound to one or more polymers.

A nanoparticle is a composite of a few to thousands of atoms or molecules and has a size, which typically lies in the range of 1 to 100 nanometers.

Nanoparticles have, relative to their volume and relative to their weight, a large surface area. Thus, e.g. soot particle have surface areas of 10-1000 m²/g, and noble metal particles have surface areas in the range, 250-300 m²/g. Predetermined nanoparticles with predetermined properties chemically bond with predetermined polymers. Obtained are stable chemical bonds, or at least one stable chemical bond between polymer and nanoparticle. Interactions, such as van der Waals interactions, dipole interactions or hydrogen bonds are not counted as chemical bonds in the sense of the invention, since these involve weak attraction forces between individual molecules.

Monomers are combined in polyreactions, especially polymerization, polycondensation, polyaddition or metathesis reactions, to form polymers. The used nanoparticles are suitable for forming chemical bonds with the polymers during and/or after, or the monomers before and/or during, the polyreactions, e.g. the nanoparticles have one or more functional, reactive, end groups. According to the invention, at least one nanoparticle is chemically bonded to a polymer. The chemical bond can, however, also be produced between a nanoparticle and a monomer, wherein this monomer then bonds with additional monomers to form a polymer. According to the invention, thus, at least one nanoparticle is chemically bound stably to a basic building block of a polymer.

If monomers of the same physical/chemical properties are combined to polymers, these polymers are called uni- or homopolymers. Polymers formed of different types of monomers are called copolymers. The nanoparticles used according to the invention have predetermined physical/chemical properties. In such case, according to the invention, nanoparticles of same physical/chemical properties can be chemically bonded with monomers or polymers, wherein the monomers have same physical/chemical properties and thus homopolymers are present, or wherein at least two monomers of different physical/chemical properties bond to form a copolymer. Or, nanoparticles of different types, thus with different physical/chemical properties, are chemically bonded with monomers having, in turn, same or different physical/chemical properties, or with polymers, thus, correspondingly, with homo- or copolymers.

The predetermined properties of the nanoparticles provide the synthetic material or plastic of the invention with predetermined properties. Thus, the synthetic material or plastic can, for example, be made hydrophobic, wherein not only its surface is made hydrophobic through coating with a hydrophobic material, but, instead, by binding the nanoparticles into the polymers during the polyreactions, the entire synthetic material or plastic is made hydrophobic, since the nanoparticles are chemically bound into the structure of the synthetic material or plastic. Thus, this synthetic material or plastic remains hydrophobic even when its surface changes over its lifetime due to abrasion or by contact with aggressive media. Because of the chemical bonding, the nanoparticles are not directly dissolvable out of the synthetic material or plastic, and also a migration in the synthetic material or plastic is, thus, suppressed. The synthetic material or plastic can, according to the invention, have homogeneous properties. The polymer fraction of the synthetic material or plastic of the invention can also be referred to as the matrix, in which matrix the nanoparticles are bound.

Nanoparticles can, in such case, be both organic as well as also inorganic. In the polymer, they are in connection with the invention likewise referred to as basic building blocks of the polymer. They can be bound on the end of a polymer or in the chain of the basic building blocks of the polymer.

Known are synthetic material or plastic containing polymers, which contain metal atoms, i.e. the metal atoms are components of the main chain of the polymer and hold the polymer backbone together via covalent or coordinative bonds or, however, they can be attached laterally to the polymer directly or via spacers. These polymers are called hybrid polymers. Also, a synthetic material or plastic of the invention could be referred to as an organic, respectively inorganic, hybrid polymer.

In a further development of the invention, the one or more nanoparticles are chemically bound by a radical reaction, such as e.g. an oligo- or polymerization reaction, by a condensation-, by an addition- or by a metathesis reaction, to the one or more polymers.

Polyinsertion, also called coordinative polymerization, is, in such case, a special form of polymerization. The polymerization can occur, for example, radically, electrophilically, nucleophilically or just by polyinsertion. The nanoparticles are, thus, chemically bonded by the same chemical reaction to basic building blocks of the one or more polymers, same as other basic building blocks.

In an additional further development of the invention, the one or more nanoparticles have one or more predetermined end groups, which are suitable for forming a chemical bond with the one or more polymers.

The nanoparticles are correspondingly selected or end group modified. Of course, these nanoparticles are then also suitable for forming one or more stable chemical bonds with one or more monomers, which are combined to form the polymer,. Especially, the nanoparticles have the same end groups as the monomers, which are combined to form the polymers. If different monomers are combined to form copolymers, the nanoparticles have at least the same end group as one of the monomers of the copolymer.

In an additional further development of the invention, monomers with predetermined, e.g. also reactive, end groups are combined with one or more nanoparticles with one or more predetermined, e.g. also reactive, end groups, to form polymers.

Known to those skilled in the art is that reactive end groups are not necessary for polymerization reactions, but are for polycondensation- or polyaddition reactions.

The terminology, end group modified, means that nanoparticles of the present invention have a reactive group. If the polymers are also end group modified, they also have a reactive group on the α- or ω-end of the polymer. The term, reactive, means that the end group is one, which is capable of radical addition polymerization, -copolymerization, -oligomerization or -dimerization.

The predetermined end group or groups of the nanoparticle is/are suitable for reacting with the one or more functional groups, especially end groups, of the polymers and for forming a chemically stable bonding. Nanoparticles are, thus, chemically permanently bonded with the polymers by chemical reaction with one or more monomers or polymers, either between two or more monomers or polymers, or to the end of a monomer or polymer.

Examples of polymers include PUR, PFA or PTFE.

If the polymers are, for example, polyurethanes, then the nanoparticles have correspondingly modified end groups, in order to bond chemically to isocyanate groups, for example, at least one hydroxy- or isocyanate group, a primary or secondary amino group, an allophanate group, an epoxide group or a carbamate- or carbamate analog group.

In an additional further development of the method of the invention, the one or more nanoparticles comprise end group modified, pyrogenic, silicic acids.

In a further development of the invention, the nanoparticles come from the group of chemical compounds of the silanes, especially the oxygen-containing acids of silicon, the silicic acids. Alternatively thereto, the nanoparticles come, for example, from the chemical groups of the alkanes. End group modified, pyrogenic, silicic acids are used, for example, in order to obtain a hydrophobic synthetic material or plastic and therewith a hydrophobic lining. The used nanoparticles exhibit, for example, the chemical functionality, amino, diamino, ureido, alk-oxy or mercapto, i.e. they have then at least one amino group, ureido group, alk-oxy group or mercapto group as end group.

In a further development, nanoparticles are added in a predetermined concentration to the starting substances, so that they are present in a concentration of 0.1 to 5 wt.-%, especially 1 to 2 wt.-%, in the synthetic material or plastic.

Included in the starting substances or also educts of the method can be, besides the monomers or, in given cases, prepolymers, additional materials, such as e.g. solvent and/or catalysts, which, in given cases, are not part of the synthetic material or plastic of the invention and are only present for reaction purposes.

First, according to a further development of the invention, a liquid multicomponent system is formed. This includes at least one prepolymer or at least two monomers, an alcohol, especially a difunctional alcohol, and a catalyst. Furthermore, it includes nanoparticles in a predetermined amount. These can, in such case, have been added already separately before the forming of the multicomponent system to the monomers or the prepolymer, the alcohol, or the catalyst or they can be added to the multicomponent system, which then forms the synthetic material or plastic from the polymer chemically bonded with the nanoparticle by chemical reaction and hardens as such.

According to an embodiment of the invention, the polyurethane is produced on the basis of a multicomponent system, which is formed by means of a prepolymer, an alcohol, especially a difunctional alcohol, and the catalyst. According to an additional embodiment of the invention, the applied prepolymer includes ether groups, especially aliphatic ether groups. According to an additional embodiment of the invention, the applied prepolymer includes aromatic compounds. According to an additional embodiment of the invention, the catalyst applied for manufacturing the polyurethane contains no amine, so that also the lining itself is free of amines. According to an additional embodiment of the invention, the catalyst applied for manufacturing the polyurethane contains no heavy metals, so that also the lining itself is free of heavy metals. According to an additional embodiment of the invention, the catalyst applied for manufacturing the polyurethane contains tin and the lining includes atomically bonded tin.

According to an additional embodiment of the method of the invention, the applied catalyst comprises tin organo compounds, such as e.g. di-n-octyl tin compounds. According to an additional embodiment of the method of the invention, the catalyst is a di-n-octyl tin dilaurate and/or a di-n-octyl tin dimalinate. According to an additional embodiment of the method of the invention, the prepolymer includes ether groups, especially aliphatic and/or aromatic, ether groups. According to an additional embodiment of the method of the invention, the prepolymer includes aromatic or aliphatic isocyanate groups. According to an additional embodiment of the method of the invention, the prepolymer includes at least two reactive NCO groups. According to an additional embodiment of the method of the invention, the alcohol includes at least two functional OH groups. According to an additional embodiment of the method of the invention, the alcohol is a diol, especially a butane diol. According to an additional embodiment of the method of the invention, it is performed at a working temperature of less than 100° C., especially at, for instance, 25° C.

In an embodiment of the method of the invention, a liquid multicomponent system is formed of an isocyanate, an alcohol and a nanoscale silicic acid having an isocyanate end group.

In the method of the invention for manufacturing a lining for a measuring tube of a flow measuring device, a synthetic material or plastic of the invention is used for the lining, wherein, in a first method step, a liquid multicomponent system is formed of at least one prepolymer or a plurality of monomers, and a nanoparticle, wherein, in an additional method step, the liquid multicomponent system is applied on an inner wall of a support tube, especially a metal, support tube, especially according to the known ribbon-flow method, and caused to harden.

The synthetic material or plastic of the invention is obtainable by the manufacturing method of the invention. It comprises, thus, a polymer having a chemically bound nanoparticle.

A lining of the invention for a measuring tube of a flow measuring device is manufacturable by the method of the invention. For example, the lining comprises a polymer, in which end group modified nanoparticles are chemically bound.

A measuring tube of the invention for a flow measuring device comprises a support tube, especially a metal support tube, and a lining according to the preceding claim lining the support tube.

A flow measuring device according to the invention, especially an in-line flow measuring device, comprises a measuring tube of the invention having a lining of the invention. The flow measuring device of the invention can be embodied, for example, in the form of an ultrasonic flow measuring device or in the form of a magneto inductive flow measuring device.

According to a further development of the invention, a measuring transducer includes: a magnetic circuit arrangement arranged on the measuring tube for producing and guiding a magnetic field, which induces an electrical field in the flowing fluid; and measuring electrodes for tapping an electrical voltage induced in the flowing fluid.

1-15. (canceled)

16. A measuring tube lining of a synthetic material or plastic produced with a method for manufacturing a synthetic material or plastic for a lining of a measuring tube of a flow measuring device, wherein:
nanoparticles are bound chemically to monomers, oligomers or polymers as components of the synthetic material or plastic; and
monomers having predetermined end groups are combined with nanoparticles having predetermined end groups to form polymers.

17. The measuring tube lining as claimed in claim 16, wherein:
said nanoparticles are chemically bound to said monomers, oligomers or polymers by one of: radical reactions, condensation-, addition- and metathesis reactions.

18. The measuring tube lining as claimed in claim 16, wherein:
said nanoparticles each have one or more end groups, which are suitable for forming a chemical bond with said monomer, said oligomer or said polymer.

19. The measuring tube lining as claimed in claim 16, wherein:
said polymers comprise PUR, PFA or PTFE.

20. The measuring tube lining as claimed in claim 16, wherein:
said nanoparticles comprise end group modified, pyrogenic, silicic acids.

21. The measuring tube lining as claimed in claim 16, wherein:
said nanoparticles are added in a predetermined concentration to the starting substances, so that said nanoparticles are present in the synthetic material or plastic in a concentration of 0.1 to 5 wt.-%.

22. The measuring tube lining as claimed in claim 16, wherein:
a liquid multicomponent system is formed, which contains monomers or prepolymers, an alcohol, a catalyst and said nanoparticles;
said monomers or said prepolymers react with said nanoparticles to form a chemically stable bond; and
said multicomponent system hardens.

23. The measuring tube lining as claimed in claim 16, wherein:
a liquid multicomponent system is formed of an isocyanate, an alcohol and a nanoscale silicic acid having an isocyanate end group or an alcohol group.

24. The measuring tube lining as claimed in claim 16, wherein:
a synthetic material or plastic is used for lining;
in a first method step, a liquid multicomponent system is formed of at least one prepolymer or a plurality of monomers and a nanoparticle; and
in an additional method step, the liquid multicomponent system is applied on an inner wall of a support tube and cured.

25. A measuring tube for a flow measuring device, comprising:
a support tube; and a lining of a synthetic material or plastic produced with a method for manufacturing a synthetic material or plastic for a lining of a measuring tube of a flow measuring device, wherein:
nanoparticles are bound chemically to monomers, oligomers or polymers as components of the synthetic material or plastic; and monomers having predetermined end groups are combined with nanoparticles having predetermined end groups to form polymers.

26. A flow measuring device, comprising:
a lined measuring tube lining of a synthetic material or plastic produced by a method for manufacturing a synthetic material or plastic for a lining of a measuring tube of a flow measuring device, wherein:
nanoparticles are bound chemically to monomers, oligomers or polymers as components of the synthetic material or plastic; and
monomers having predetermined end groups are combined with nanoparticles having predetermined end groups to form polymers.

27. The flow measuring device as claimed in claim 26, wherein:
the flow measuring device is a magneto inductive flow measuring device.

28. A synthetic material or plastic for lining of a measuring tube of a flow measuring device, manufactured by a method for manufacturing a synthetic material or plastic for a lining of a measuring tube of a flow measuring device, wherein:
nanoparticles are bound chemically to monomers, oligomers or polymers as components of the synthetic material or plastic; and
monomers having predetermined end groups are combined with nanoparticles having predetermined end groups to form polymers.
